(19) United States
(12) Patent Application Publication
(10) Pub. No.: US 2013/0088370 A1
(43) Pub. Date: Apr. 11, 2013

(54) CROSSING GATE TIP SENSOR

(71) Applicants: Richard C. Carlson, Wauconda, IL (US); Kurt Gunther, Round Lake Heights, IL (US)

(72) Inventors: Richard C. Carlson, Wauconda, IL (US); Kurt Gunther, Round Lake Heights, IL (US)

(21) Appl. No.: 13/644,737

(22) Filed: Oct. 4, 2012

Related U.S. Application Data
(60) Provisional application No. 61/627,269, filed on Oct. 11, 2011.

(51) Int. Cl. G08G 1/00

(52) U.S. Cl. CPC G08G 1/00
USPC 340/932.1

(57) ABSTRACT

Systems, methods, routines and/or techniques for a crossing gate tip sensor are described. According to one or more embodiments of the present disclosure, a crossing gate tip sensor may be attached to or incorporated into a gate arm of a crossing gate. The crossing gate tip sensor may accurately detect the orientation (among other things) of the gate arm. In some embodiments, a crossing gate tip sensor may include a tilt sensor that includes one or more accelerometers. In some embodiments, a crossing gate tip sensor may include a microcontroller and/or a wireless communication unit.

### CROSS-REFERENCE TO RELATED APPLICATIONS

This application claims priority from the following U.S. Provisional Patent Applications No. 61/627,269 filed on Oct. 11, 2011. The disclosure of the provisional patent application is incorporated by reference herein in its entirety.

### FIELD

The present disclosure relates to crossing gates, for example, at the intersection of a railroad track and a road, and more particularly to one or more systems, methods, routines and/or techniques for a crossing gate tip sensor.

### BACKGROUND

Railroad crossing gates are used to prevent vehicles from crossing a track where a train is expected to pass in the near future. For example, a railroad crossing gate may be installed at a location where a road intersects a railroad track. Some railroad crossing gates include a long gate arm that acts as a barrier to force a vehicle to stop. The gate arm is normally oriented in an upright or vertical position, when no train passing is imminent. When a train approaches an intersection, the gate arm swings or lowers down to a horizontal position.

### SUMMARY

The present disclosure describes one or more systems, methods, routines and/or techniques for a crossing gate tip sensor. According to one or more embodiments of the present disclosure, a crossing gate tip sensor may be attached to or incorporated into a gate arm of a crossing gate. The crossing gate tip sensor may accurately detect the orientation (among other things) of the gate arm. Various descriptions included herein may describe a crossing gate tip sensor incorporated into a crossing gate related to a railroad track, for example, a railroad track upon which trains and other rail line vehicles may pass. It should be understood, however, that the systems, methods, routines and/or techniques of the present disclosure may be applied to various other types of crossing gates, for example, a crossing gate installed at the intersection of two automobile paths.

These and other advantages, aspects and novel features of the present disclosure, as well as details of an illustrated embodiment thereof, will be more fully understood from the following description and drawings. It is to be understood that the foregoing general descriptions are exemplary and explanatory only and are not restrictive of the disclosure as claimed.

### BRIEF DESCRIPTION OF THE DRAWINGS

Several features and advantages are described in the following disclosure, in which several embodiments are explained, using the following drawings as examples.

FIG. 1 depicts an angled-top-view illustration of an example crossing gate tip sensor and related components, according to one or more embodiments of the present disclosure.

FIG. 2 depicts block diagram of an example setup that includes one or more crossing gate tip sensors and a crossing control unit and/or bungalow, according to one or more embodiments of the present disclosure.

### DETAILED DESCRIPTION

Various crossing gates are designed such that a gate arm swings or lowers down to a horizontal position when a train traveling on a track approaches an intersection (e.g., an intersection perpendicular to the track). In various situations, it may be important that the gate arm swings completely down to a horizontal and straight (e.g., parallel to the track) position or swings completely up to a vertical and straight position. In some situations, rules (e.g., federally mandated rules) may require that gate arms complete the raising process a specific period of time before a train arrives at the intersection, or complete the lowering process a specific period of time after a train leaves the intersection. For various reasons, a particular gate arm may not lower or raise in an appropriate manner, for example, the gate arm (and/or related gate parts) may have been damaged, dislodged or broken, for example, due to a vehicular impact. Various crossing gates have no accurate method to determine when the gate arm is completely lowered or raised, nor do they have a method to determine the timing or status related to the lowering or raising of the gate arm. For various reasons (e.g., federally mandated rules, safety, design restrictions and the like), various crossing gates cannot include additional signal cables. Furthermore, for various reasons, various crossing gates cannot include additional signal cables to connect the gate to a crossing control unit (e.g., included in a “bungalow”).

The present disclosure describes one or more systems, methods, routines and/or techniques for a crossing gate tip sensor. According to one or more embodiments of the present disclosure, a crossing gate tip sensor may be attached to or incorporated into a gate arm of a crossing gate. The crossing gate tip sensor may accurately detect the orientation (among other things) of the gate arm. Various descriptions included herein may describe a crossing gate tip sensor incorporated into a crossing gate related to a railroad track, for example, a railroad track upon which trains and other rail line vehicles may pass. It should be understood, however, that the systems, methods, routines and/or techniques of the present disclosure may be applied to various other types of crossing gates, for example, a crossing gate installed at the intersection of two automobile paths.

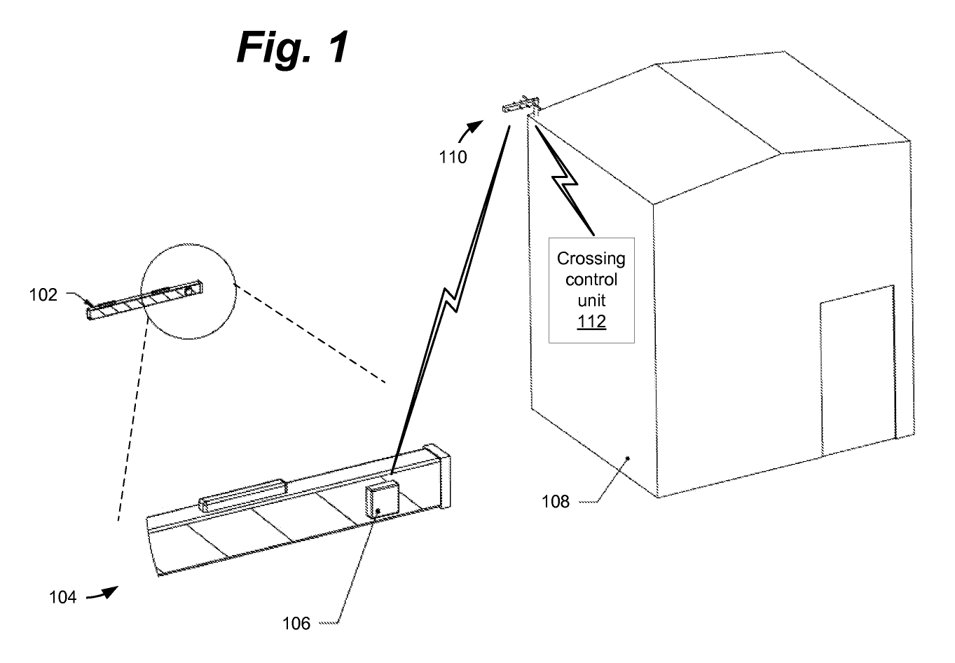

FIG. 1 depicts an angled-top-view illustration of an example crossing gate tip sensor and related components, according to one or more embodiments of the present disclosure. FIG. 1 shows an example crossing gate arm 102. Crossing gate arm may be part of a crossing gate that may be located at the intersection of a railroad track and a road, for example. FIG. 1 also shows a close-up view 104 of the crossing gate arm 102. As can be seen in FIG. 1, a crossing gate tip sensor 106 may be attached, mounted to and/or incorporated into the gate arm 102. The crossing gate tip sensor 106 may accurately detect the orientation (among other things) of the gate arm 102. The crossing gate tip sensor 106 may be in communication with a crossing control unit 112 (e.g., included in a bungalow 108). The crossing control unit 112 may include and/or be in communication with an antenna 110, for example, an external antenna mounted on the exterior of bungalow 108. The crossing gate tip sensor 106 may communicate wirelessly with the antenna 110 to, in turn, communicate with the crossing control unit 112.

The crossing gate tip sensor 106 may include a tilt sensor, for example, a solid state 3-axis tilt sensor. A tilt sensor may be a component that includes one or more accelerometers and optionally, other sensors. A tilt sensor may detect various aspects about its orientation, for example, the angle of orientation in various planes (e.g., X-plane, Y-plane, Z-plane) and/or the speed and/or acceleration of the change in angle. A tilt sensor may produce various digital and/or analog signals based on the various orientation conditions it detects. The crossing gate tip sensor 106 may include a gate integrity detection component, for example, that can detect if a gate is broken, damaged or vandalized. A tilt sensor may provide information that may indicate that a gate is broken, damaged or vandalized, but the gate integrity detection component may provide additional information about the integrity of the gate.

The crossing gate tip sensor 106 may include a wireless communication component to communicate with a crossing control unit/bungalow. For example, a crossing gate tip sensor 106 may include a frequency hopping radio system (e.g., a 900 Mhz radio, transceiver, antenna, etc.). The wireless communication component may adapt the crossing gate tip sensor 106 to communicate with the crossing control unit/bungalow without wired signal cables. The crossing gate tip sensor 106, via the wireless communication component, may communicate (and/or receive) various pieces of information to the crossing control unit/bungalow, for example, exact gate arm 102 position and/or orientation. As another example, the crossing gate tip sensor 106, via the wireless communication component, may communicate information about whether a gate is broken, damaged or vandalized. The information communicated to the crossing control unit/bungalow may include various warnings about the integrity and/or operation and/or status and/or orientation of a crossing gate.

The crossing gate tip sensor 106 may include a power source and/or a power component that is designed to use power from an existing power source. For example, a power source may be a battery or a capacitor. As another example, a power component (e.g., included in the crossing gate tip sensor) may connect to an existing power source of another component of the crossing gate. For example, the power component connect to an existing warning light system wire harness, for example, which may be located on the crossing gate. In some embodiments, a power component (e.g., connected to an existing power source) may charge an internal power source (e.g., a battery and/or a capacitor) in the crossing gate tip sensor.

The bungalow 108 may include a crossing control unit 112. The crossing control unit may include various components, modules, circuitry, connections and the like. The crossing control unit 112 may communicate (e.g., via antenna 110) with one or more crossing gates. The crossing control unit 112 may detect when various crossing gates are oriented in the vertical position or when they are lowered. In some embodiments, the crossing control unit 112 may communicate with various crossing gates to instruct the crossing gates to lower or raise. The crossing control unit 112 may include a user interface. The user interface may allow a user to perform initial setup or calibration of various gates. The user interface may allow a user to see status, warnings and the like related to the integrity, orientation and the like of various gates.

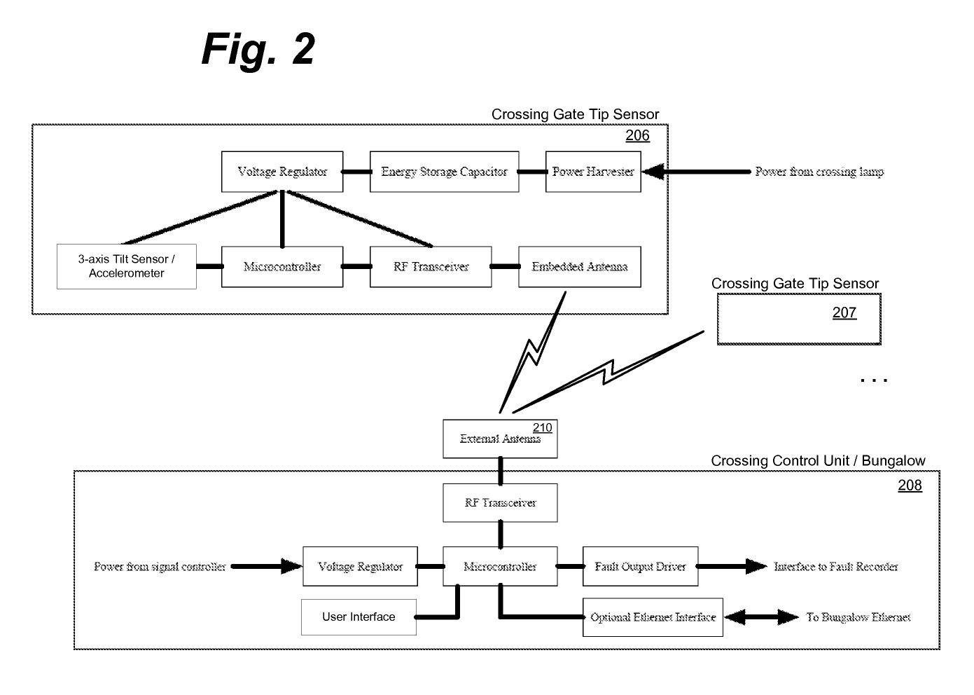

FIG. 2 depicts block diagram of an example setup that includes one or more crossing gate tip sensors and a crossing control unit and/or bungalow, according to one or more embodiments of the present disclosure. FIG. 2 shows an example crossing gate tip sensor 206, which may be similar to the crossing gate tip sensor 106 of FIG. 1, for example. The setup may include a number of other crossing gate tip sensors, for example, crossing gate tip sensor 207. Crossing gate tip sensor 206 may include various components, sensors, connections and the like. For example, as shown in FIG. 2, crossing gate tip sensor 206 may include a 3-axis tilt sensor/accelerometer, as explained about with regard to FIG. 1. Crossing gate tip sensor 206 may include a microcontroller. Crossing gate tip sensor 206 may include various components and/or connections that adapt the crossing gate tip sensor 206 to communicate with a crossing control unit and/or bungalow, for example, an RF transceiver and an antenna (e.g., an embedded antenna). Crossing gate tip sensor 206 may include various components and/or connections that adapt the crossing gate tip sensor 206 to receive and/or store energy to power the various components of the crossing gate tip sensor. For example, crossing gate tip sensor 206 may include a power harvester, for example, to receive power from an existing power source, such as a crossing lamp. Crossing gate tip sensor 206 may include an energy store, for example, a battery or a capacitor (as shown in FIG. 2). Crossing gate tip sensor 206 may include a voltage regulator that may condition the power from the energy store before passing it to other components of the crossing gate tip sensor 206.

FIG. 2 shows an example crossing control unit 208 (e.g., included inside a bungalow). Crossing control unit 208 may include and/or be in communication with an antenna 210 (e.g., an external antenna mounted on a bungalow). Crossing control unit 208 may communicate with one or more crossing gates and/or crossing gate tip sensors (e.g., 206, 207) via the antenna 210. Crossing control unit 208 may include an RF transceiver that pairs with the antenna 210. As shown in FIG. 2, crossing control unit 208 may include various other components, sensors, connections and the like. For example, crossing control unit 208 may include a microcontroller. Crossing control unit 208 may include a voltage regulator, for example, to condition power from a signal controller. Crossing control unit 208 may include a user interface, as explained above with regard to FIG. 1. Crossing control unit 208 may include a fault output driver, for example, to interface with a fault recorder. Crossing control unit 208 may include various communication interfaces, for example, an Ethernet interface that may connect to an Ethernet connection within the bungalow.

In operation, and referring again to FIG. 1, a gate tip sensor 106 may communicate with the crossing control unit to send and/or receive information. For example, if it is detected (e.g., by components in the bungalow 108) that a rail line vehicle is approaching the crossing gate, the crossing control unit 112 may send a signal to the crossing gate that it should raise its gate arm 102. Alternatively, the detection of an approaching vehicle may occur in or near the crossing gate itself. The crossing gate may proceed to raise the gate arm 102 from a substantially horizontal (lowered) position to a substantially vertical (raised) position. During and/or after the gate arm 102 is lifted, the crossing gate tip sensor 106 may communicate various pieces of information to the crossing control unit. In this respect, the crossing control unit may continuously maintain updated information about the status of the gate arm 102. After the train passes through and leaves the intersection, the crossing gate may lower its gate arm 102. During and/or after the gate arm 102 is lowered, the crossing gate tip sensor 106 may communicate various pieces of information to the crossing control unit. In this respect, the crossing control unit may continuously maintain updated information about the status of the gate arm 102. If at any point the gate arm is not operating in an appropriate manner, the crossing gate tip sensor may communicate one or more warnings to the crossing control unit 112. The crossing control unit 112 may then perform various operations based on this information. For example, if the malfunction of the gate arm is serious (e.g., the gate arm is not raising or lowering fully), the crossing control unit 112 may initiate a warning, for example, to warn an approaching rail vehicle or automobile. In some situations, the crossing control unit 112 may initiate a message to one or more entities to indicate that a crossing gate may be in need of maintenance.

The description of the different advantageous embodiments has been presented for purposes of illustration and the description and is not intended to be exhaustive or limited to the embodiments in the form disclosed. Many modifications and variations will be apparent to those of ordinary skill in the art. Further different advantageous embodiments may provide different advantages as compared to other advantageous embodiments. The embodiment or embodiments selected are chosen and described in order to best explain the principles of the embodiments of the practical application and to enable others of ordinary skill in the art to understand the disclosure for various embodiments with various modifications as are suited to the particular use contemplated.

1. A crossing gate tip sensor, comprising a sensor module attached or incorporated into a crossing gate arm, wherein the sensor module includes:
a tilt sensor that includes one or more accelerometers;
a microcontroller; and
a wireless communication unit.

2. The crossing gate tip sensor of claim 1, wherein the sensor module is adapted to detect the orientation of the crossing gate arm.

3. The crossing gate tip sensor of claim 1, wherein the sensor module is adapted to detect the orientation of the crossing gate arm in three dimensions or planes.

4. The crossing gate tip sensor of claim 1, wherein the sensor module is adapted to detect the speed of change of orientation of the crossing gate arm.

5. The crossing gate tip sensor of claim 1, wherein the sensor module is adapted to detect the acceleration of change of orientation of the crossing gate arm.
